(19) United States
(12) Patent Application Publication
(10) Pub. No.: US 2018/0184777 A1
(43) Pub. Date: Jul. 5, 2018

(54) MULTI-FUNCTIONAL LUGGAGE SOLUTION

(71) Applicant: Incase Designs Corp., Los Angeles, CA (US)

(72) Inventors: Hyun Hong, Los Angeles, CA (US); Hokoon Yau, Anaheim, CA (US); Amin Dahrehsobh, Los Angeles, CA (US); Eddie Cheung, Chino Hills, CA (US)

(21) Appl. No.: 15/863,862

(22) Filed: Jan. 5, 2018

Related U.S. Application Data
(60) Provisional application No. 62/442,443, filed on Jan. 5, 2017.

(51) Int. Cl. A45C 15/00; A45C 5/03; A45C 5/06; A45C 13/26; A45C 5/14; A45C 13/10; A45C 13/00; H02J 7/00

(52) U.S. Cl. CPC A45C 15/00; A45C 5/03; A45C 5/06; A45C 13/262; A45C 5/143; H04W 4/80; A45C 13/005; H02J 7/0021; A45C 2013/267; A45C 2005/037; A45C 13/103

(57) ABSTRACT

A multi-functional luggage solution and interactive wireless luggage management system is disclosed. In one implementation, the luggage has a horizontally extending electronic device storage and charging tray compartment positioned strategically in its top portion and accessible through an opening in the top surface of the luggage. Reversibly detachable swivel wheels are mounted to the bottom portion, which allows for on the go reduction in the dimensions of the suitcase to accommodate small or limited storage conditions. A removable rechargeable battery cartridge that is configured to be fixedly retained within a battery compartment located within the tray compartment or within the handle well of the suitcase. The battery cartridge includes wireless connectivity capable of facilitating Bluetooth and/or wireless internet/network communication with a remote electronic mobile device, such as a smartphone, computing tablet, or laptop computing device or the like. Various functionalities, such as GPS tracking, proximity location, alarm activation, luggage locking, and battery monitoring and management can thereby be remotely facilitated. The removable rechargeable battery cartridge is configured to charge one or more electronic device as a standalone battery bank or when installed into the suitcase through electrically connected access ports mounted on the suitcase.

### INCORPORATION BY REFERENCE TO RELATED APPLICATIONS

This application claims the benefit of priority under 35 U.S.C. § 119(e) to U.S. Provisional Application No. 62/442,443, filed Jan. 5, 2017 and titled “MULTI-FUNCTIONAL LUGGAGE SOLUTION”. The above application is hereby incorporated herein by reference in its entirety and is to be considered a part of this specification.

### BACKGROUND OF THE INVENTION

### Field of the Invention

This invention relates to multi-functional luggage solutions.

### Description of the Related Art

For people who regularly travel or are on the go, whether for work or personal getaways, their luggage is an increasingly important and integral aspect of ensuring hassle free transport, protection, and security of travelers and their business and/or personal items. These days, perhaps some of the most important items carried by travelers are their mobile or portable electronic devices, such as smart phones, computing tablets, laptops, MP3/audio players, gaming devices, headphones, or other portable handheld or wearable electronic devices. The inability to secure such devices or the loss or lack of operability of such devices can cause significant anxiety and disruption to a traveler. To mitigate these issues, seasoned travelers often use rolling carryon size travel cases to avoid parting with their electronic devices and delay or loss that can occur with checking in bags. In addition, such travelers frequently travel with back-up batteries or battery banks to facilitate recharging their electronic devices when charging facilities are not conveniently available.

Even so, it is not uncommon for travelers to find that their roller bag is too big to fit in the carryon compartment, on a small or crowded plane for example, thereby requiring that the bag be checked in—a dreaded situation for many travelers. Moreover, these days with added security and the need or desire to be constantly connected, it is not uncommon for travelers to find themselves frequently removing and storing their devices in and out of their luggage and/or carryon bags, which can be an inconvenient undertaking. Additionally, while battery banks can provide charging capabilities, conventional banks can be difficult to manage during the hustle and bustle of travel, including clearing them with security, and can be easily misplaced, lost, or stolen.

The inventors here have recognized that there is a continued need, therefore, for luggage solutions that are capable of overcoming the foregoing shortcomings and enhancing the a traveler's experience.

### BRIEF SUMMARY OF THE INVENTION

Disclosed here are numerous aspects of a unique and inventive multi-functional luggage solution and interactive wireless luggage management system. For example, in one aspect the luggage has a horizontally extending electronic device storage and charging tray compartment positioned strategically in its top portion and accessible through an opening in the top surface of the luggage. In another aspect, the luggage includes reversibly detachable wheels mounted to the bottom portion that is capable of reducing the longitudinal or vertical dimensions of the luggage when the wheels are removed. In yet another aspect, the luggage includes a removable rechargeable battery cartridge that is configured to be fixedly retained within a battery compartment located within the tray compartment. In yet another aspect, the removable rechargeable battery cartridge includes wireless connectivity capable of facilitating wireless internet access and/or wireless communication with another electronic mobile device, such as a smartphone, computing tablet, or laptop computing device or the like. Various functionalities, such as GPS tracking, proximity location, alarm activation, luggage locking, and battery monitoring can thereby be remotely facilitated, each of which alone and in combination constitute yet aspects. In yet another aspect, the removable rechargeable battery cartridge is configured to be capable of charging one or more electronic devices when it is removed from the battery compartment or alternatively when it is retained within the battery compartment. In yet another aspect, the luggage is configured to electrically connect the removable rechargeable battery cartridge, when retained within the battery compartment, to one or more access ports that are mounted externally to the tray compartment and/or one or more access ports that are mounted internally to the tray compartment and may further connect to an electronically activated locking mechanism.

It should be understood that each of the foregoing and various aspects, together with those set forth in the claims and summarized above and/or otherwise disclosed herein, including the drawings, may be combined to support claims for a device, apparatus, system, method of manufacture, and/or use without limitation.

### BRIEF DESCRIPTION OF THE DRAWINGS

These and other features, aspects and advantages are described below with reference to the drawings, which are intended to illustrate, but not to limit, the invention. In the drawings, like reference characters denote corresponding features consistently throughout similar embodiments.

FIGS. 1A and 1B are front perspective views, taken from the left and right sides respectively of an exemplary implementation of a multifunctional suitcase in accordance with the teachings herein.

FIGS. 2A-2F are front, back, left, right, top and bottom side views of the suitcase illustrated in FIGS. 1A-1B.

FIGS. 3A-3C are top side perspective views of the suitcase illustrated in FIGS. 1A-1B, showing operation of the top cover panel to reveal the top tray compartment, with FIGS. 3A and 3B illustrating the top cover panel in the closed position and FIG. 3C illustrating the top cover panel in the open position to reveal the top tray compartment and the removable rechargeable battery cartridge.

FIGS. 4A and 4B are partial top perspective views of the suitcase illustrated in FIGS. 1A-1B further depicting the unlatching and removal of the removable rechargeable battery cartridge from the top tray compartment.

FIGS. 5A-5C are partial top perspective views of the of the suitcase illustrated in FIGS. 1A-1B depicting in more detail the various electrical connectors. FIG. 5A depicts a the battery compartment with the removable rechargeable battery cartridge removed therefrom to reveal the electrical the electrical connector in the battery compartment that couples with the battery connector when the removable rechargeable battery cartridge is installed or docked within the battery compartment of the top tray compartment. FIG. 5A also depicts lever arms that are configured to assist in removing the removable rechargeable battery cartridge from the batter compartment and further depicts an access port cover for the external power access ports illustrated in FIG. 5C. FIG. 5B depicts a representative power access port mounted to the sidewall of the tray compartment to allow for charging of an electronic device. FIG. 5C depicts a plurality of representative power access ports mounted externally on the left side of the suitcase to allow for simultaneous charging.

FIGS. 6A-6B are illustrations of a the removable rechargeable battery cartridge of the suitcase illustrated in FIGS. 1A-1B, with FIG. 6A being a depiction of the external configuration the removable rechargeable battery cartridge and FIG. 6B being a depiction of the components of the removable rechargeable battery cartridge in an exemplary architecture and environment between the removable rechargeable battery cartridge, a network (e.g., the internet) and a remote mobile electronic device.

FIGS. 7A-7B are perspective view illustrations of the bottom portion of the suitcase illustrated in FIGS. 1A-1B, disassembled from the remaining portions of the suitcase, to better illustrate the unitary wheel tray configuration. The bottom portion is illustrated with the swivel wheels mounted thereto.

FIGS. 8A-8D are perspective view illustrations of the bottom portion of the suitcase illustrated in FIGS. 1A-1B, depicting detachment and removal of the swivel wheels. FIG. 8D depicts a bottom portion configuration that includes two swivel wheels mounted thereto and two front feet mounted in place of two removed swivel wheels, which thereby allows the suitcase to be converted from a four wheel roller to a two wheel roller type suitcase.

FIGS. 9A-9B are vertical and horizontal cross-sectional views, respectively, of a representative swivel wheel of the suitcase illustrated in FIGS. 1A-1B to illustrate in more detail components of the detachable wheel mounting system. The cross-sections are depicted with the connection pin extending from the bottom portion inserted within the support sleeve of the wheel and retentively locked by a biased button clasp mechanism.

FIGS. 10A-10C are partial perspective views of the perimeter regions of the top portion of the suitcase illustrated in FIGS. 1A-1B depicting the handle system and how the handle system is mounted with outer and inner support brackets to the top portion of the suitcase.

FIGS. 11A-11F illustrate exemplary screen shots of a user interface for interacting with the removable rechargeable battery cartridge of the suitcase illustrated in FIGS. 1A-1B.

FIGS. 12A-12B are back side perspective views, taken from the left side of another exemplary implementation of a multifunctional suitcase in accordance with the teachings herein. The removable rechargeable battery cartridge in this alternative suitcase is positioned within a battery compartment that opens-up into the handle well of the top portion of the suitcase and is protected by the handle when the handle is in the closed position. The removable rechargeable battery cartridge includes the same access ports on its side as the removable rechargeable battery cartridge depicted in FIGS. 6A-6B, which serve to provide accessible charging capability when the rechargeable battery cartridge is either installed or removed from the battery compartment.

FIGS. 13A-13C are back side perspective views of another exemplary implementation of a multifunctional suitcase in accordance with the teachings herein. The removable rechargeable battery cartridge in this alternative suitcase is positioned vertically within a battery compartment that opens-up between the handles in the handle well of the top portion of the suitcase and is protected by the handle when the handle is in the closed position.

Each drawing is generally to scale and hence relative dimensions of the various components can be determined from the drawings.

### DETAILED DESCRIPTION OF THE PREFERRED EMBODIMENT

As summarized above and illustrated in the drawings, disclosed herein are various aspects of a multi-functional luggage solution. Many of those aspects are summarized above and illustrated in the drawings.

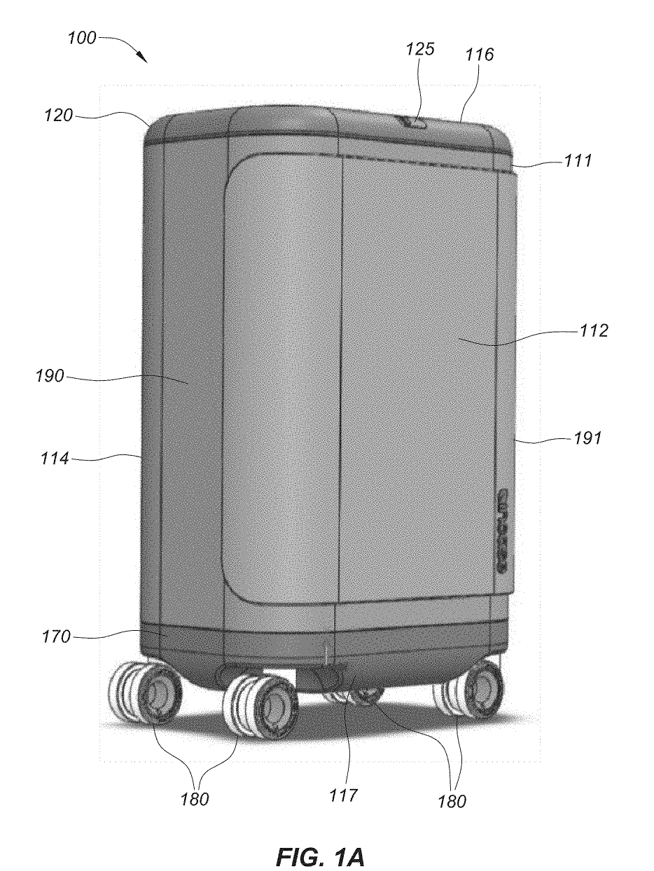

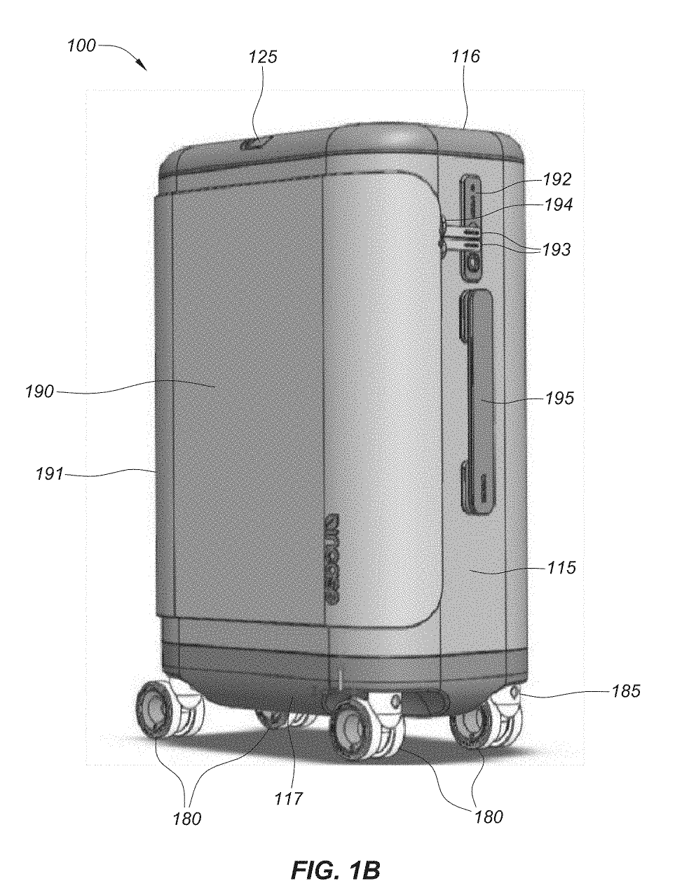

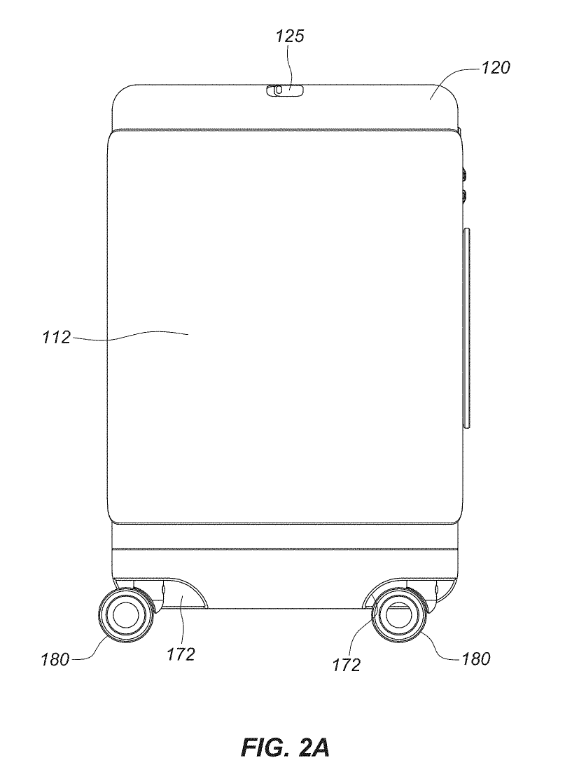

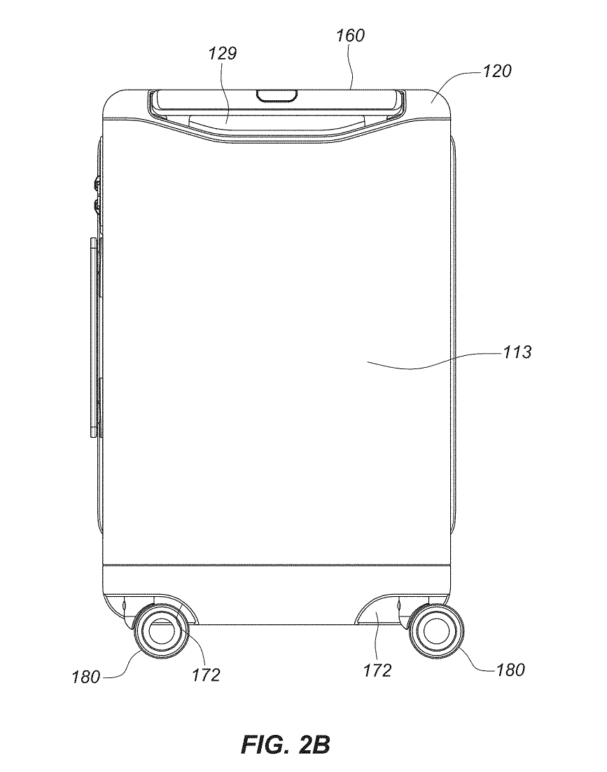

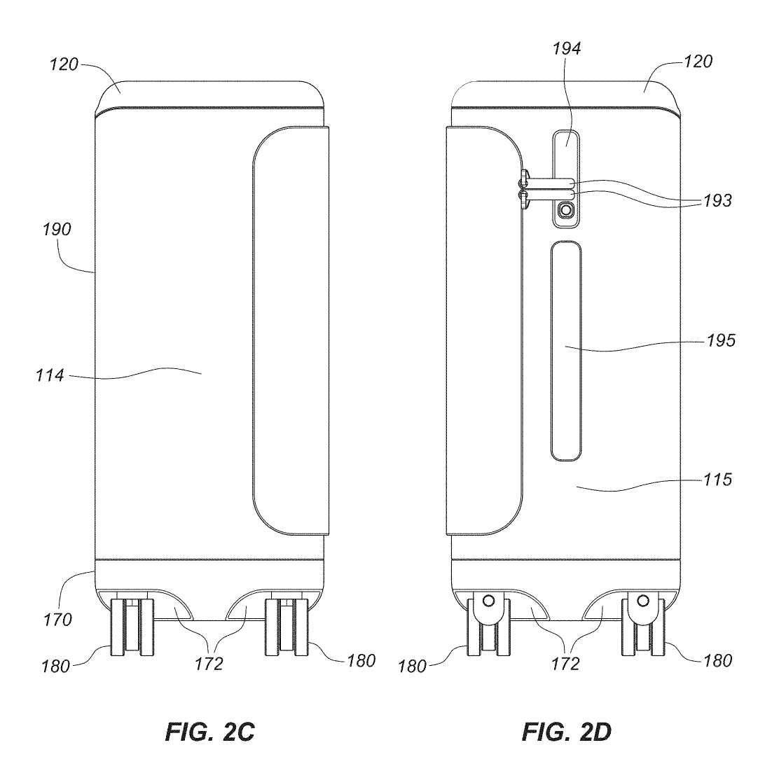

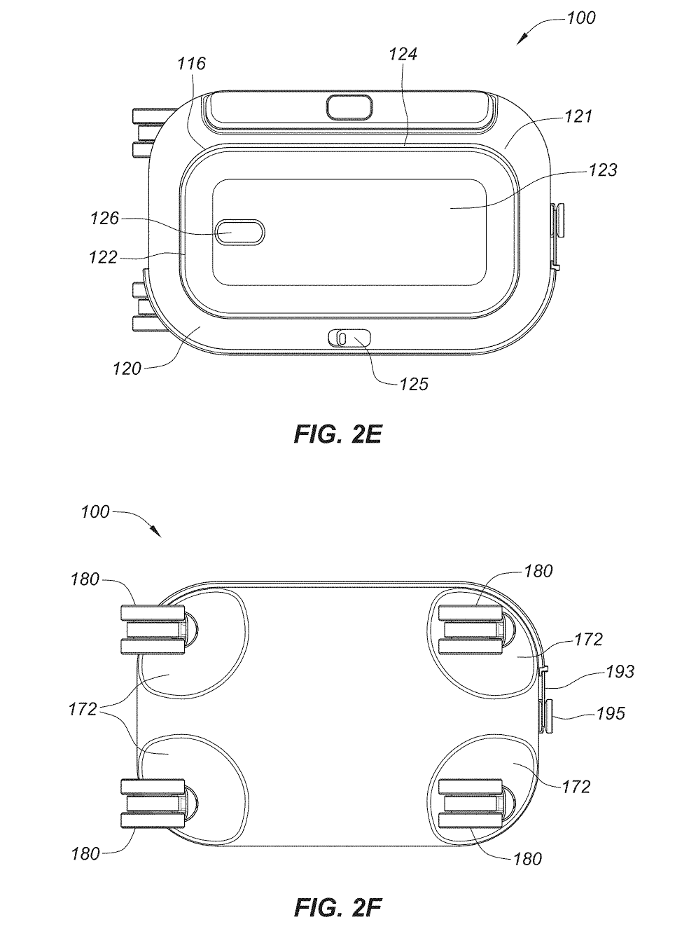

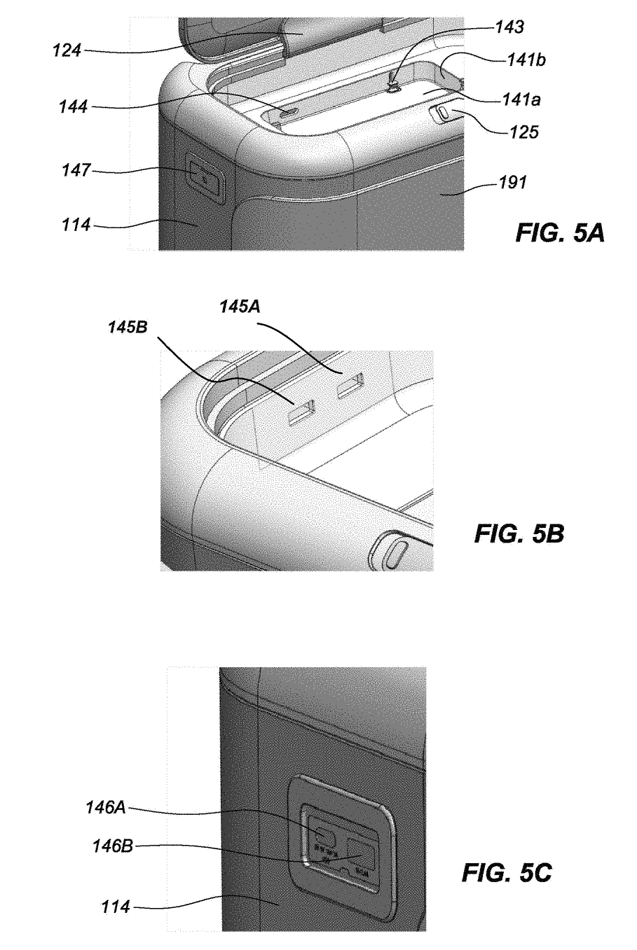

As set forth above, disclosed in FIGS. 1-13 are various aspect of a luggage solution. As illustrated therein a suitcase 100 is disclosed that includes an elongated body 110 having an external surface 111 and front side, back side, left side, right side, top side and bottom sides 112, 113, 114, 115, 116, and 117 that merge at corner regions 118 and define a primary or main storage compartment 119 for the user to store clothing and other items.

The suitcase 100 includes a top portion 120, a bottom portion 170 and middle portion 190 connected to and extending there between and further includes a wirelessly enabled removable rechargeable battery bank cartridge 150 that is capable of communicating with a remote wireless enabled mobile or portable device 200.

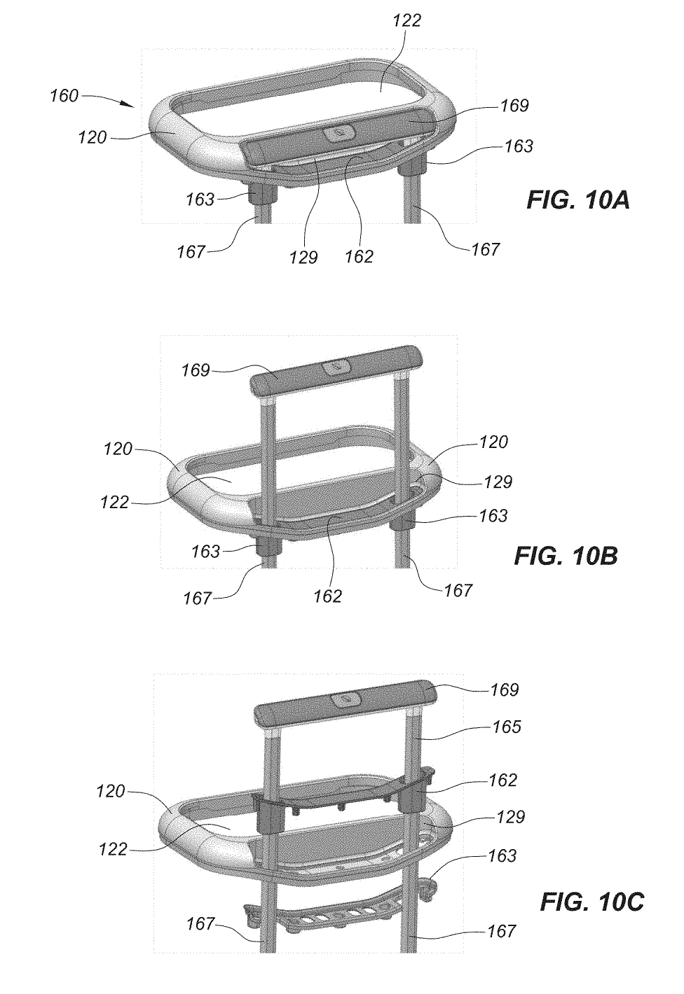

The top portion 120 includes a top external surface 121 that has a tray access opening 122 that provides access to a tray compartment 130. A tray access door 123 is provided to cover the access opening 122 and is connected to the top surface via a hinge 124, which may be conventional mechanical door hinge or living hinge. A latch 125 may be provide adjacent to the tray access door 123 to secure the tray access door 123 in the closed position. Alternatively, the tray access door 123 may be secured to the opening 122 via a perimeter zipper 128 (not shown). A cable pass through opening 126 may also be provided through the tray access door 123 to facilitate cable management with the tray compartment 130. Separate Zippered pouch compartment 127 may be incorporated on one or both sides of the tray access door 123 to provide additional strategic and convenient storage for electronics, passport, travel tickets, wallet, and/or electronic accessory devices. A handle well 129 is also formed on the external surface 121 of the top portion 120 and is positioned near the back side 113 of the suitcase 100. The perimeter regions of the top portion may be formed as a unitary molded polymer component as best illustrated in the disassembled view of the top portion depicted in FIGS. 10A-10C.

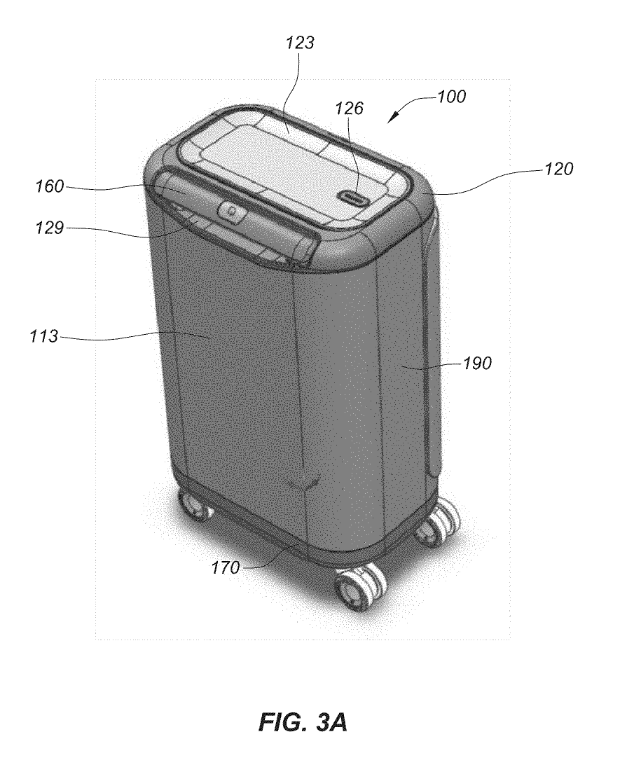

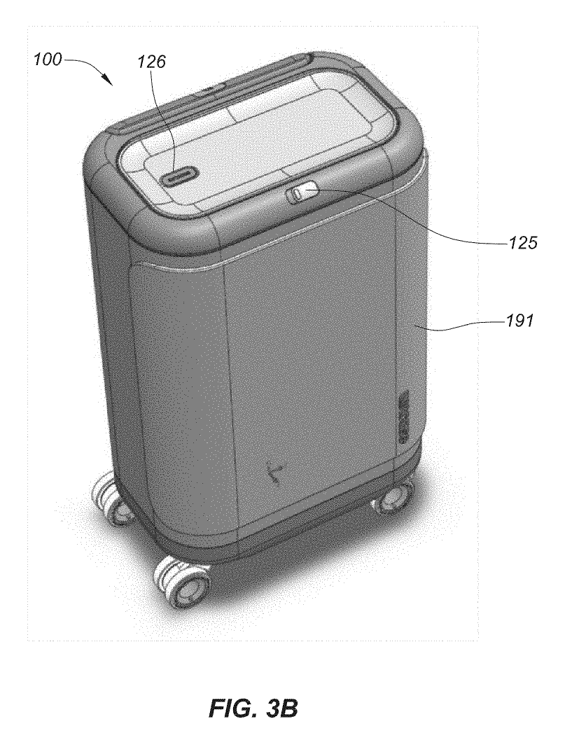

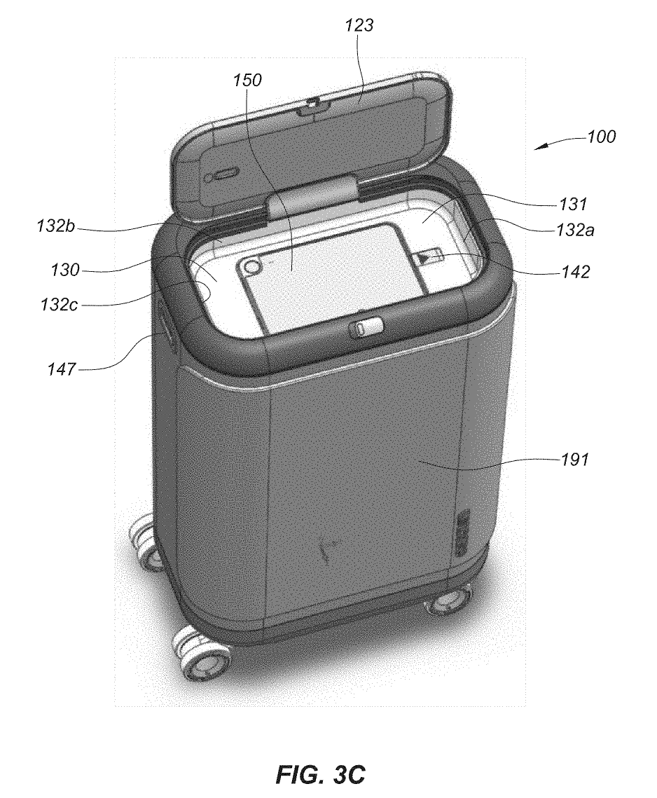

The tray compartment 130 in the top portion 120, as best depicted in FIGS. 3C-5B, includes a horizontally extending surface 131 surrounded by a side walls 132a-d. A battery compartment 140 is formed into the bottom of the tray compartment 130 and is defined by a bottom wall 141a and surrounded by side walls 141b. A battery cartridge retention latch 142 is positioned adjacent to the battery compartment 140 on one thereof and is configured to engage the exterior of the removable rechargeable battery bank cartridge 150 to lock the cartridge into the battery compartment 140. The retention 142 may also be coupled to levers 143 positioned in the battery compartment 140 that function to push the battery cartridge 150 out of the battery compartment when the latch 142 is activated.

Electrical connector (e.g., a pogo type connector) 144 is positioned within the batter compartment 140 and are configured to engage with the battery interface (e.g., also pogo type connector) 154c when the battery cartridge 150 is installed in the battery compartment 140. The suitcase 100 further includes plurality of access ports to facilitate charging with the battery cartridge 150 through conductive cables or wires (not illustrated) that extend through the suitcase 100 structure to the battery cartridge 150. In the illustrated embodiment, a plurality of internal access ports 145a and 145b positioned within the tray compartment 130 are provided as well as a plurality of external access ports 146a and 146b positioned on the external surface 111 of the suitcase 100 are provided. In the embodiment illustrated in FIGS. 3C, 4A-4B, 5A and 5C the external access ports 146a and 146b are configured to reside on the left side 114 of middle portion 190 of the suitcase 100 and are concealed and protected by an access port cover 147 (which in a preferred implementation, not illustrated, may be tethered to the suit case to mitigate against loss). The plurality of access ports may be all the same or different. For example, one of the external access ports 146a may be a USB-C fast charging connection while the other access port 146b may be a USB-A charging connection. The internal charging access ports 145a and 145b may be similarly configured or differently configured from the external charging access ports 146a and 146b.

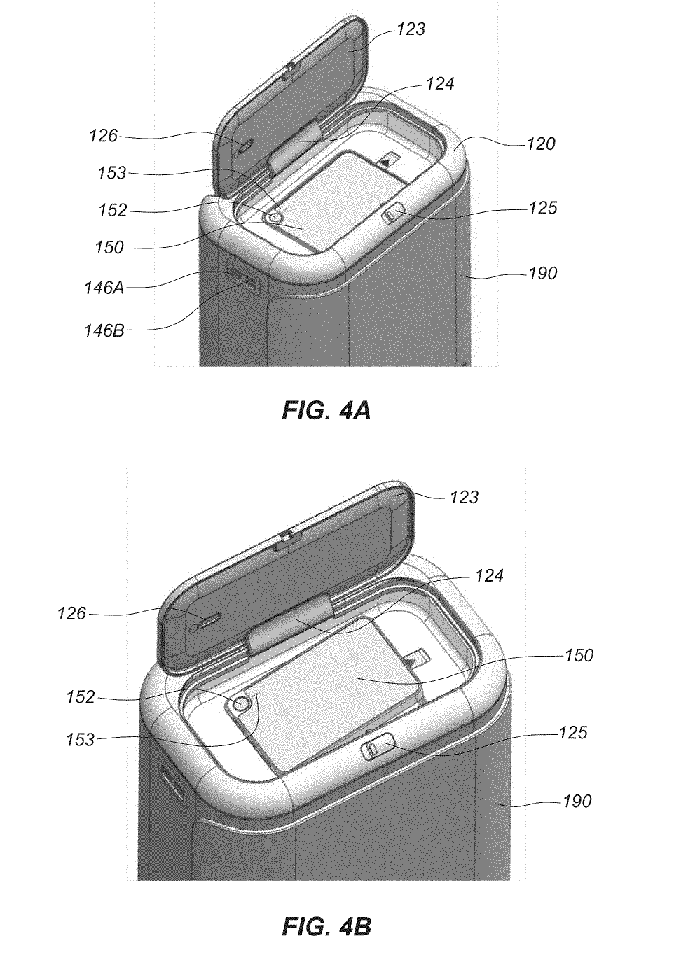

The removable rechargeable battery bank cartridge 150 is best depicted in FIGS. 3C, 4A-B and 6A-B. Externally visible on the battery bank cartridge 150 is and generally includes a Battery charge indicator 151 that is activated via a depressible button 152 that triggers a battery level display 153, which in the illustrated embodiment is a series of LED lights, which in other implementations may be a display screen. Charging ports 154a (2 USB-A) and 154b (1 USB-C port) are also externally provided on the battery cartridge 150 so as to be user accessible. The battery interface (pogo connector) 154c, which is configured to connect to the pogo connector 144 in the battery compartment 140 when the battery cartridge 150 is installed is also externally positioned. A pull table 159 (not illustrated) may also be mounted on the top face of the battery cartridge 150 to facilitate the user handling and removal of the battery cartridge 150 from the battery compartment 140. Recess 158 are also include on the external surface of the battery cartridge and are configured to engage with corresponding positioned and dimensioned protrusions on the inner surface of the battery compartment 140 to assist in retaining the battery cartridge in the battery compartment 140.

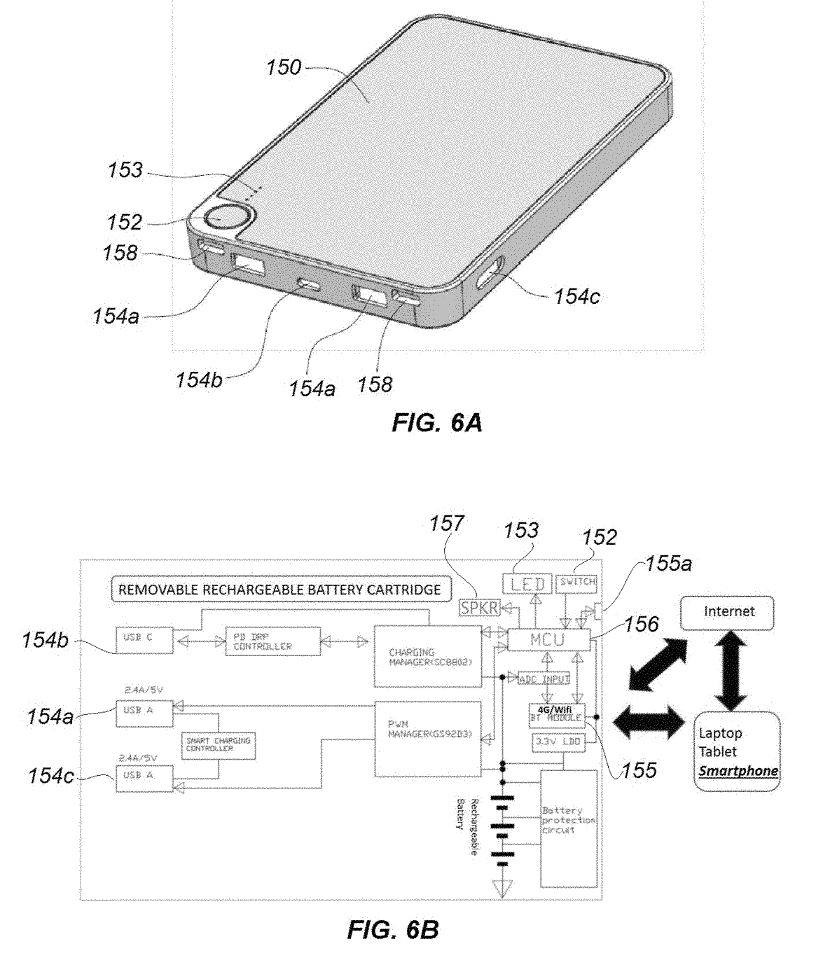

Internally the battery cartridge 150, in addition to a rechargeable battery, includes one or more wireless I/O connectivity interface/module 155 (capable of receiving and transmitting wireless signals) a wired I/O interface 155a capable of providing electronic signals to components such as an electronically controllable locking mechanism 194 that is hard wired to the battery compartment 140, a controller or processor 156 that is configured to control the functions and components of the battery cartridge 150, a speaker 157 is also provided and may be activated under certain conditions, such as when the suitcase is lost or out of proximity of the user. Other components of the battery cartridge 150 including various electronic components that operation of the battery cartridge 150 including managing power, charging and protection of the rechargeable battery contained therein are illustrated and identified in the block diagram of FIG. 6B.

A retractable handle system 160, which best illustrated in FIGS. 10A-10C, is mounted to the handle well 129 via a fixed portion 16, which includes an outer support bracket 162 and inner support bracket 163 that are mounted on either side of the handle well 120 formed in the top portion 120 of the suitcase 100. The handle system 160 further includes a movable portion 165, which on a first side 166 includes elongated legs 167 and on a second side 168 includes a handle 169.

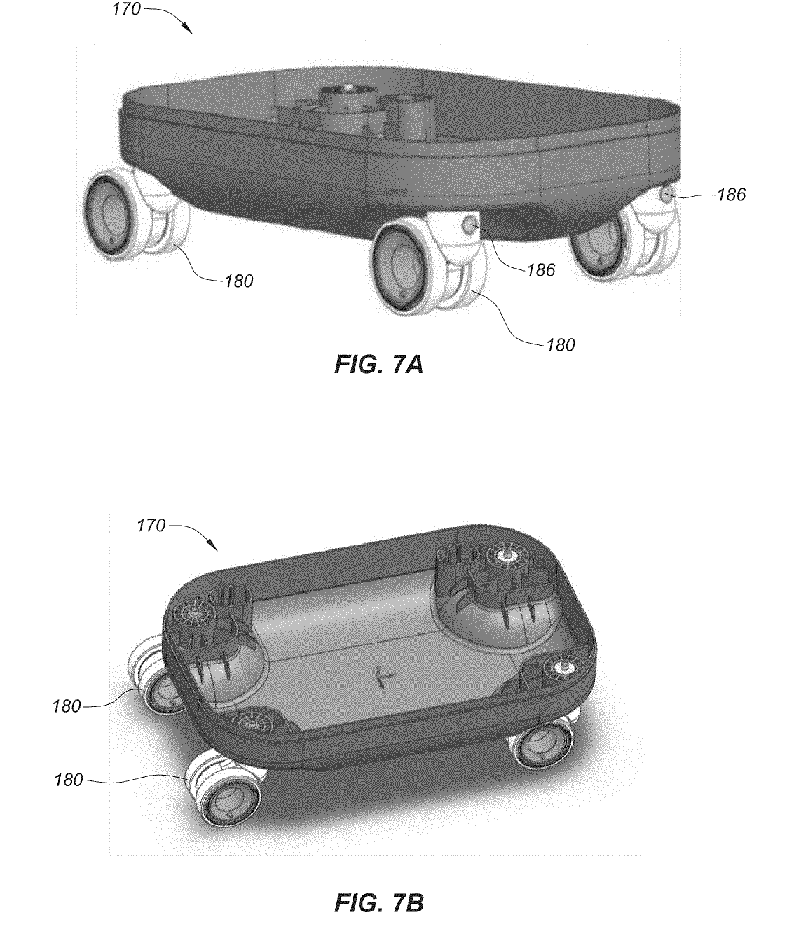

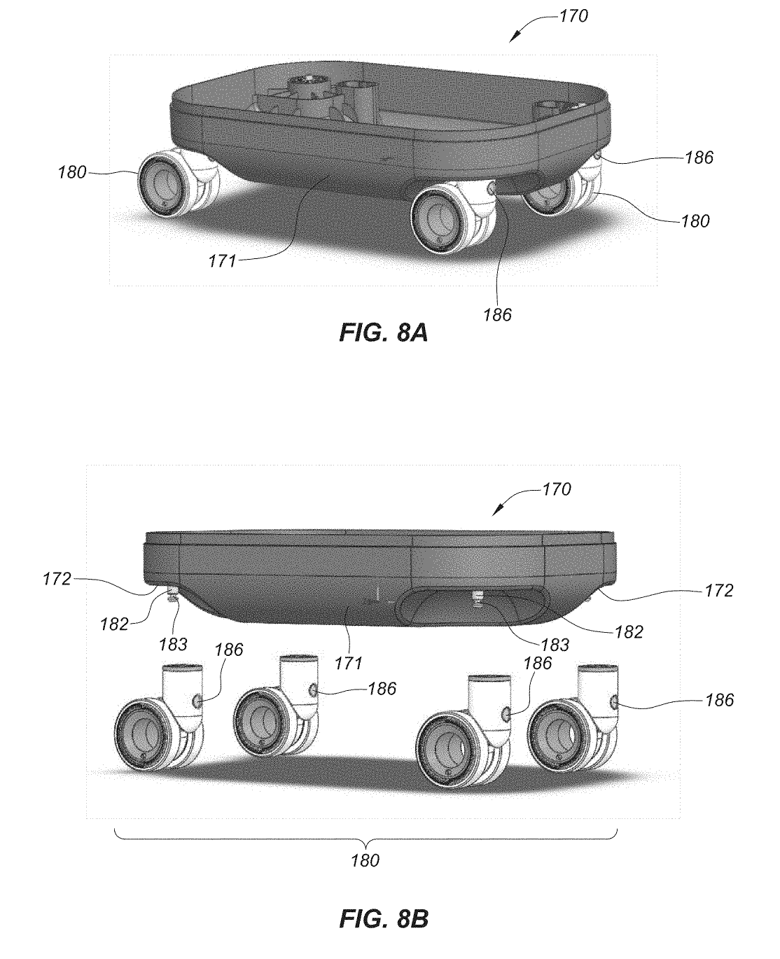

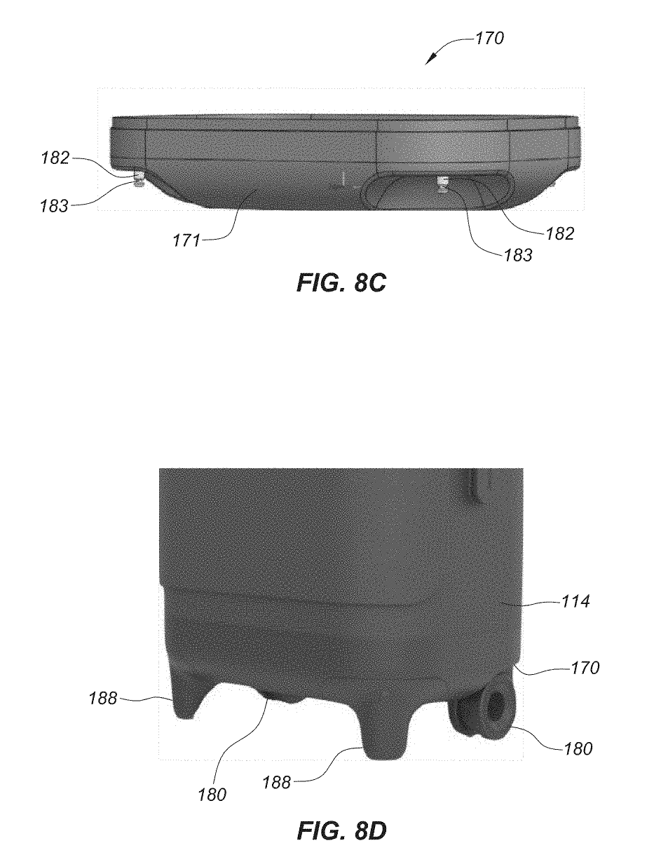

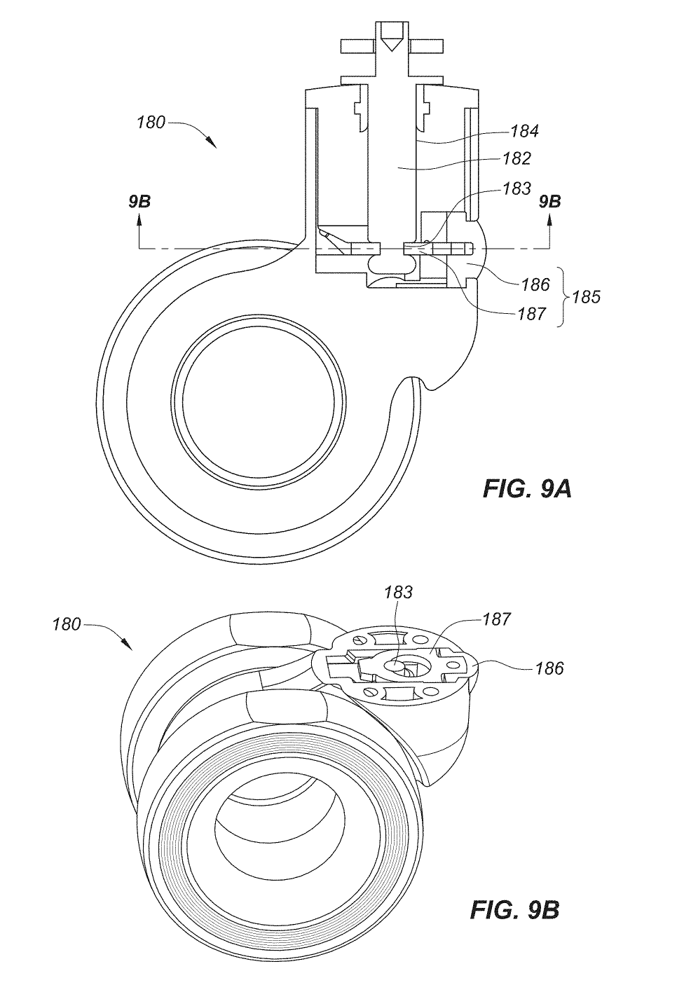

The bottom portion 170, which is best illustrated in FIGS. 7-9, is in the illustrated embodiment therein formed as a unitary molded tray having a bottom external surface 171 that includes wheel wells 172 formed therein and swivel wheels 180 reversibly attachable thereto via a detachable mounting system 181. The detachable mounting system includes a shaft/pin 182 extending from the wheel well 172, the distal end of the shaft 182 includes a recessed end region 183 that is configured to be received within a sleeve 184 extending from the support structure of the swivel wheels 180. As best illustrated in FIGS. 9A and 9B, the swivel wheels 180 include a biased depressible button 186 that when activated displaces a latch bracket 187 which in turn disengages from the recessed end region 183 of the shaft 182 thereby unlocking the wheel 182 from the shaft 182 to allow for removal of the wheels 180. Once removed the wheels 182 may be stored or replaced with detachable feet 188 such as illustrated in FIG. 8, which thereby allows the suitcase 100 to be converted from a four wheel roller to a two wheel roller type suitcase. Removal of the wheels 180 allows the user to reduce the overall length of the suitcase 100 and thereby facilitate storage of the suitcase in smaller or limited space compartments.

The middle portion 190 of the suitcase 100 contains the primary storage compartment 119, which is accessed through an access panel 191 that is secured to the adjacent regions of the suitcase via an access panel zipper 192 that includes pull tabs 193 configured to being received in and engage with an electronically controllable lock 194 mounted on the right side of the suitcase 100. The access compartment extends across the front side 112 to both the left and right 114, 115 of the suitcase 100 to provide full and convenient access to the primary storage compartment 119. The middle portion also includes carrying side handle 195 on the right side 114 to facilitate management and carrying of the suitcase 100.

In operation the removable rechargeable battery cartridge 150 is electrically connected through the pogo connections 144 and 154c to provide and control power to the internal and external power access ports 145a, 145b, 146a, 146b when the battery cartridge 150 is installed in the battery compartment 140 and may also be recharged from an external power source through one or more of those ports. In addition, when installed, the battery cartridge 150 is configured to be capable of controlling other external components such as activating the electronically controllable locking mechanism 192 that is wired to the battery compartment 140 and operatively connected to the battery cartridge 150 when installed in the battery compartment 140. When removed from the battery compartment 140, the battery cartridge 150 may be used as a standalone battery bank, may be passed through security as a standalone electronic item to avoid security line delay, and may be recharged independently of the suitcase 100.

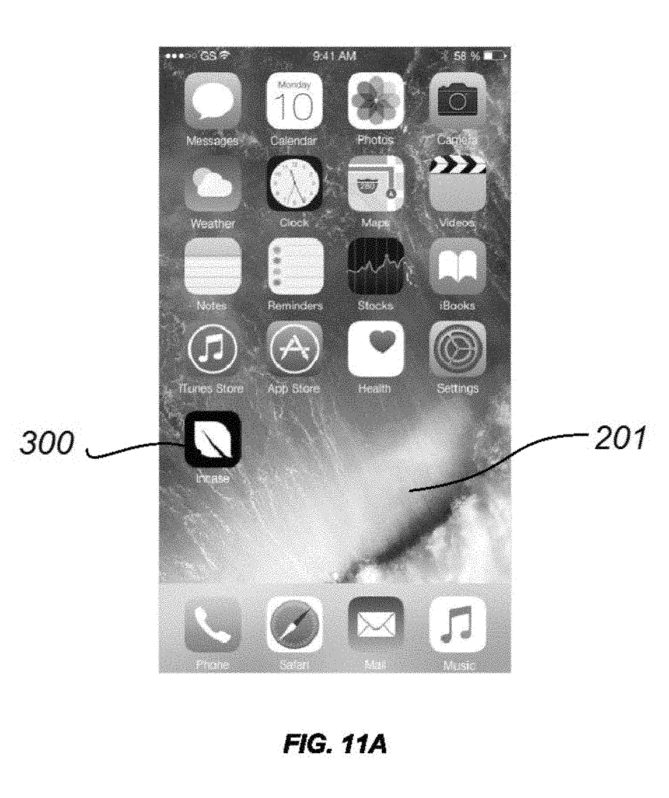

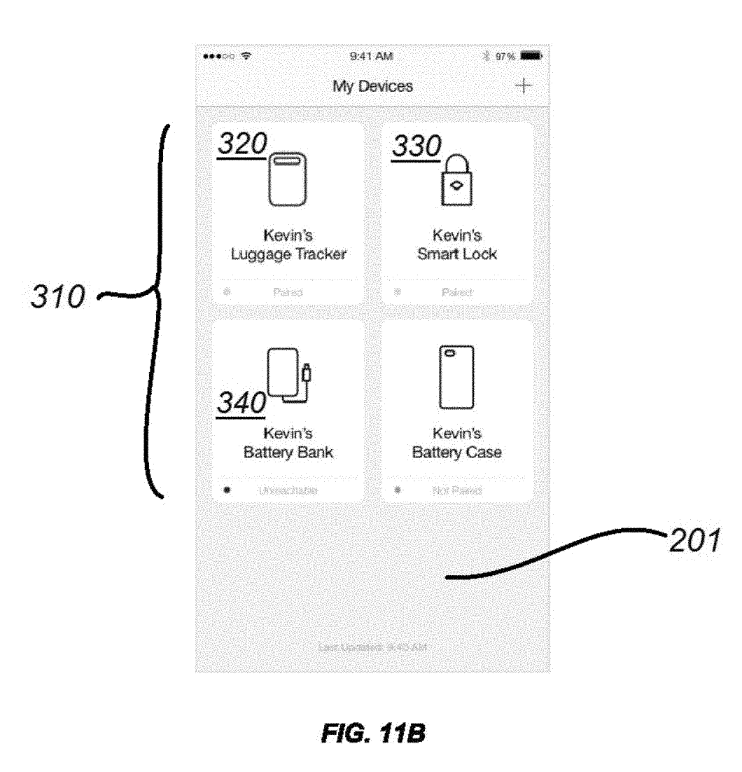

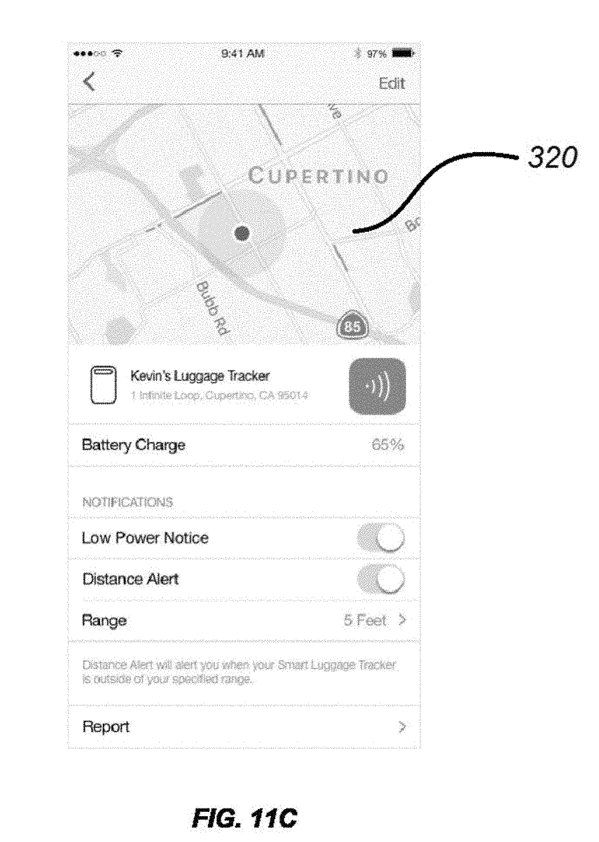

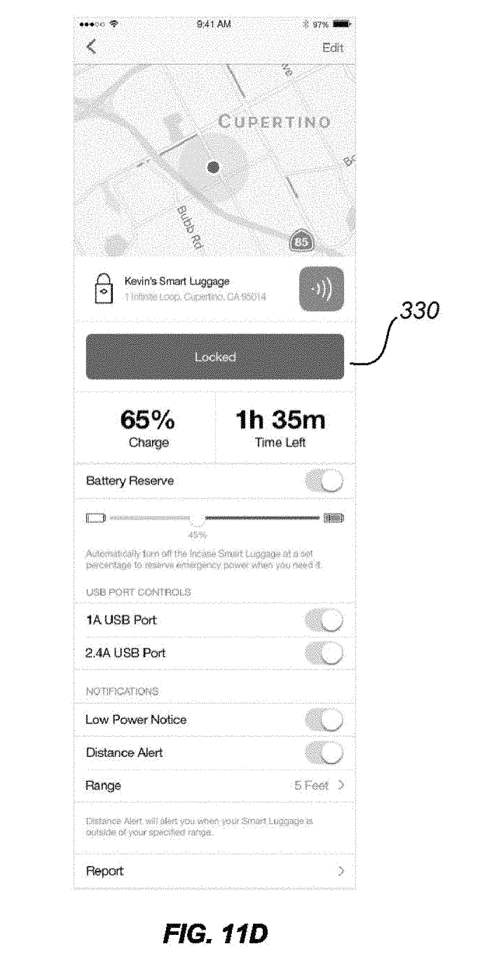

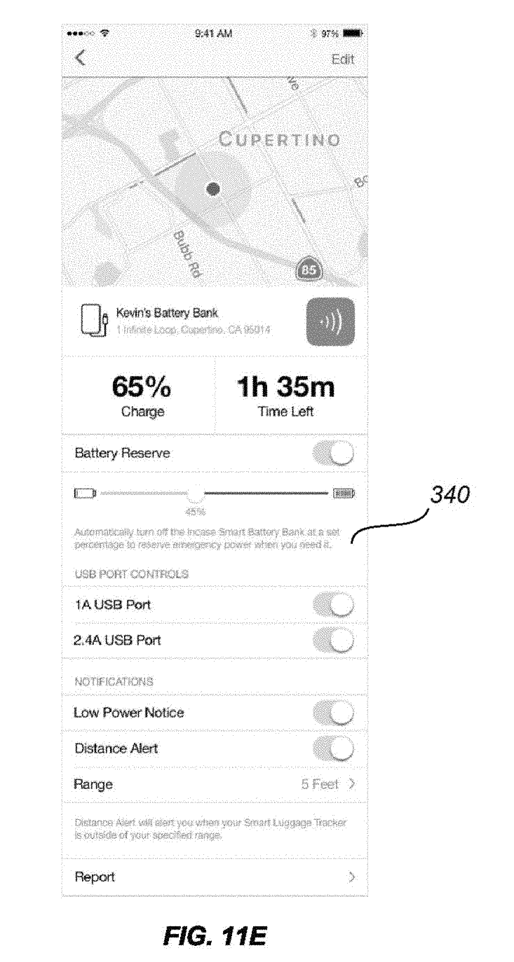

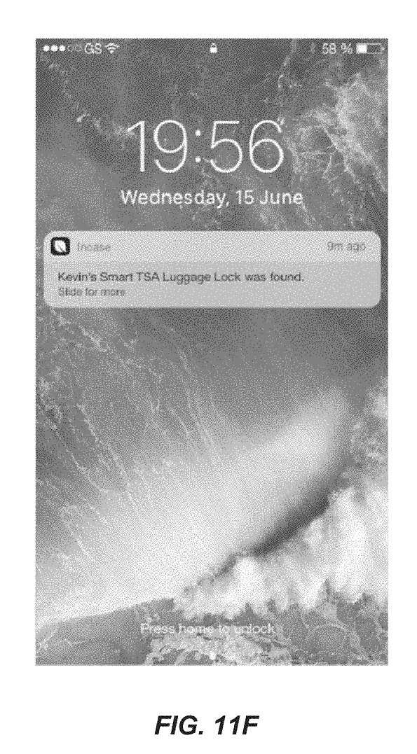

Whether removed or installed, the wireless interface(s) of the battery cartridge 150 allow for interaction with the user's correspondingly wireless enabled remote mobile or other electronic device 200 via a luggage application 300 that resides in non-transitory computer readable memory on the electronic device 200 an executed via one or more processors in the remote electronic device 200. As illustrated in FIGS. 11A-F, the luggage application can be controlled via a graphical user interactive on the touchscreen 201 of the electronic device 200.

As illustrated in FIG. 11A the luggage application may be activated by launching the application 300 from the home screen of the electronic device 200. As illustrated in FIG. 11B, once launched, various functionalities 310 are presented to the user for selection.

A luggage tracker function 320 is illustrated in FIG. 11C and allows the user to geo locate or track the suitcase 100 via the interaction between battery cartridge 150 and the remote electronic device 200 that is facilitate via either Bluetooth connectivity directly between the remote electronic device and the connectivity circuitry 155 in the battery cartridge 150 or indirectly via a wireless interne or network connection between the battery cartridge 150 and the internet/network to which the remote electronic device 200 is also connected. The same function provides battery status information of the battery cartridge 150 such as the remaining battery charge and can also provide the user an opportunity to select setting such as a distance alert and range therefore that will trigger an alarm (e.g, active and transmit an audio alarm to the speaker 157 on the battery cartridge 150) or otherwise alert the user via the mobile device screen or speaker if the battery cartridge 150 and hence the suitcase 100 (wherein the battery cartridge 150 is installed) is removed beyond a certain proximity to the remote electronic device 200.

If the smart luggage function 330 is selected from the screen illustrated in FIG. 11B, the screen user interface illustrated in FIG. 11D is provided, which allows the user to remotely determine whether the electronically controllable lock 194 is locked or unlocked and allows the user via the remote electronic device to active the electronically controllable lock via either direct Bluetooth or other wireless communication with the battery cartridge 150 as previously described in connection with FIG. 11C.

If the battery bank function 340 is selected from the screen illustrated in FIG. 11B, the screen user interface illustrated in FIG. 11E is provided, which allows the user to remotely turn on and off the battery cartridge circuitry and manage the power consumption of the battery cartridge 150 by automatically shutting off charging from the battery cartridge 150 when the battery is depleted beyond a certain percentage and to activate or deactivate charging from the various access ports.

FIG. 11F illustrates a representative notification alert. In the illustrated example, the alert indicates that the battery cartridge is now registering on GPS and can be located after being lost or out of proximity range with a wireless network or Bluetooth connection. An airplane mode that shuts down the wireless connectivity circuitry can also be implemented remotely via the luggage application or physically by depressing button 152.

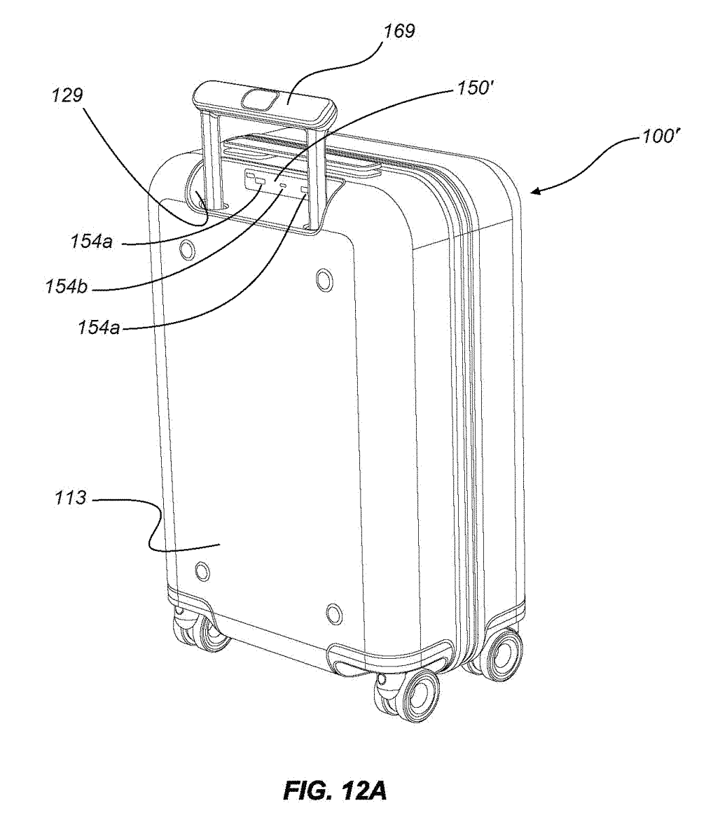

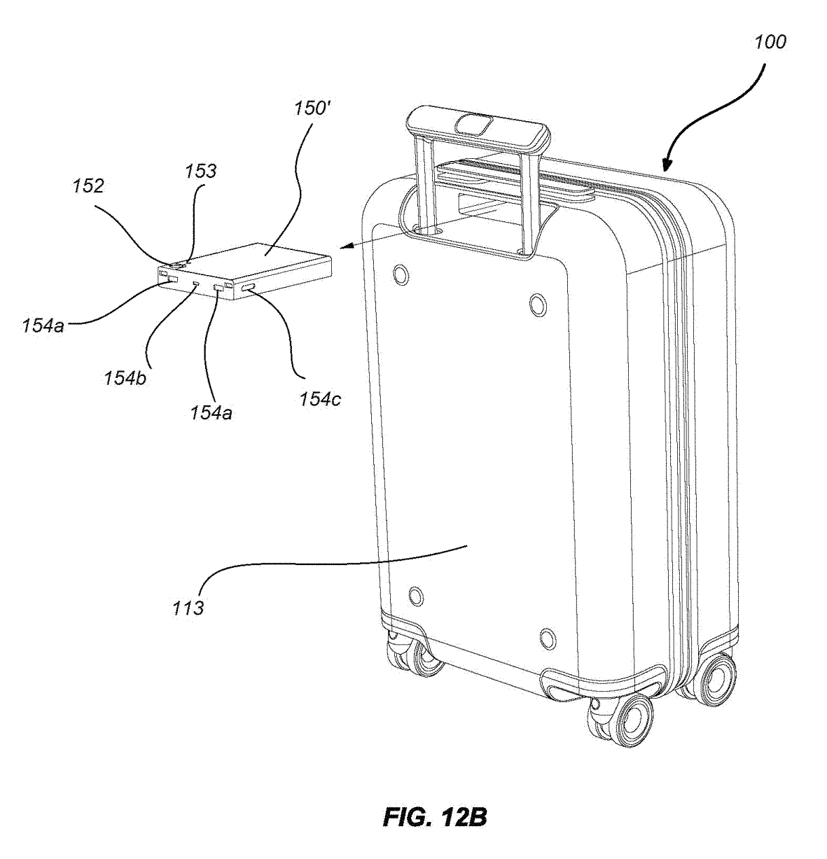

FIGS. 12A-12B illustrate another implementation of a luggage solution wherein the removable rechargeable battery cartridge 150′ as previously described is reversibly detachably installable into a battery compartment 140′ that is configured to reside within the handle well of the suitcase 100. In this configuration, the handle system provides protection to the battery cartridge 150′ when the battery cartridge is 150′ installed in the battery compartment 140′, yet allows for convenient access to the access sports 154a and 154b as well as convenient removal of the battery cartridge 150′ from the suitcase 100 by lifting the handle 169 and releasing the battery cartridge 150′ from the battery compartment 140′.

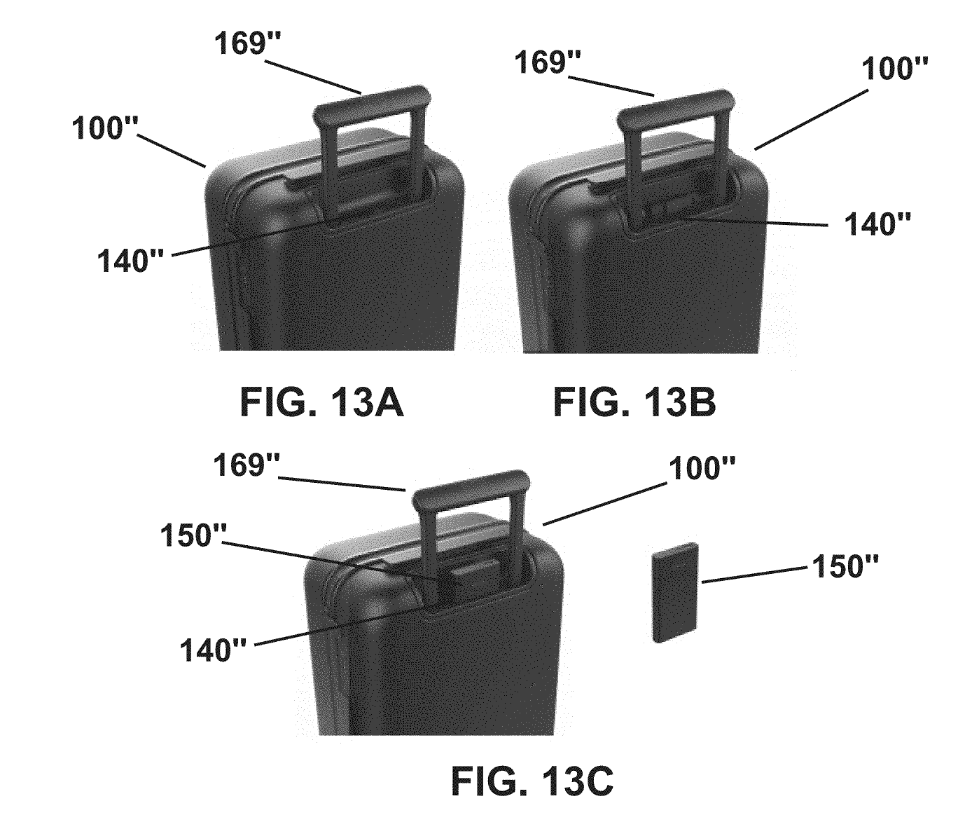

FIGS. 13A-13C illustrate another implementation of a luggage solution wherein the removable rechargeable battery cartridge 150″ as previously described is reversibly detachably installable into a battery compartment 140″ that is configured to reside within the handle well of the suitcase 100″. In the present embodiment, the battery cartridge 150″ is positioned vertically inside of a vertical battery compartment 140″ between the handles 169″ of the suitcase 100″, allowing convenient removal of the battery cartridge 150″ from the suitcase 100″ by lifting the handle 169″ and releasing the battery cartridge 150″ from the battery compartment 140″.

Although in the foregoing description only a single battery cartridge is mentioned, it is understood that multiple battery cartridges can be used and be installed in one compartment or multiple compartments without deviation from the scope of this disclosure.

Each of the foregoing and various aspects, or teachings herein together with those set forth in the claims and described in connection with the luggage described and summarized above or otherwise disclosed herein including the drawings may be combined to form claims for a device, apparatus, system, method of manufacture, and/or use without limitation.

Although the various inventive aspects are herein disclosed in the context of certain preferred embodiments, implementations, and examples, it will be understood by those skilled in the art that the present invention extends beyond the specifically disclosed embodiments to other alternative embodiments and/or uses of the invention and obvious modifications and equivalents thereof. In addition, while a number of variations of the various aspects have been shown and described in detail, other modifications, which are within their scope will be readily apparent to those of skill in the art based upon this disclosure. It should therefore be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. Thus, it is intended that the scope of the present invention herein disclosed should not be limited by the particular disclosed embodiments or implementations described above, but should be determined only by a fair reading of claims made in this patent document and any future patent document that relies on this disclosure.

Similarly, this method of disclosure, is not to be interpreted as reflecting an intention that any claim require more features than are expressly recited in that claim. Rather, as the following claims represent, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A suitcase comprising:
top portion, a bottom portion, and a vertically extending middle portion connected to and extending between said top and bottom portions;
the top portion comprising a top external surface that faces away from said bottom portion and the bottom portion comprising a bottom external surface that faces away from said top portion;
the top portion further comprising a horizontally extending tray compartment defined by a horizontally extending surface and a plurality of side walls, said tray compartment being accessible via an opening in the top external surface;
the top portion further comprising a handle system mounted thereon, the handle system includes a fixed portion that extends through the top portion and an elongated movable portion, a first side of the elongated movable portion comprising one or more elongated legs that extend through the fixed portion and a second side of the elongated movable portion being coupled to the first side and comprising a handle positioned external to the top portion; and
the bottom portion further comprising a plurality of horizontally spaced swivel wheels detachably mounted externally thereto through said bottom external surface, wherein said plurality of horizontally spaced swivel wheels are configured to permit the suitcase, when supported by said wheels, to be turned in any direction about a vertical axis.

2. The suitcase of claim 1, wherein said tray compartment is accessible via the top external surface via a door hingedly coupled to the top external surface and movable from a closed position that conceals visibility of the tray compartment to an open position that reveals the tray compartment, and wherein said top portion further includes a latch configured to engage and maintain the hinged door in the closed position.

3. The suitcase of claim 1, wherein said tray compartment includes a battery compartment configured to reversibly receive and retain a removable rechargeable battery bank cartridge.

4. The suitcase of claim 3, wherein said battery compartment is positioned in the horizontally extending surface of the tray compartment.

5. The suitcase of claim 4, wherein said battery compartment contains a removable rechargeable battery bank cartridge, and wherein said removable rechargeable battery bank cartridge is retained within said battery compartment via a battery retention latch that is configured to reside adjacent to the battery compartment.

6. The suitcase of claim 5, wherein said battery retention latch is movable from a latched position to an unlatched position, in the latched position the battery retention latch is configured to engage the removable rechargeable battery bank cartridge and maintain the removable rechargeable battery bank cartridge in a fixed position within the battery compartment, in the unlatched position, the battery retention latch is configured to disengage from the removable rechargeable battery bank cartridge.

7. The suitcase of claim 6, wherein said battery retention latch is further coupled to one or more levers positioned within the tray and operatively configured to push the removable rechargeable battery bank cartridge out of the battery compartment when the latch is moved to the unlatched position.

8. The suitcase of claim 5, wherein said removable rechargeable battery bank cartridge includes a wireless connectivity module that is configured to allow wireless communication with the removable rechargeable battery bank cartridge.

9. The suitcase of claim 8, wherein said wireless connectivity module comprises a Bluetooth wireless module.

10. The suitcase of claim 9, wherein said Bluetooth wireless module comprises a Bluetooth low energy wireless module.

11. The suitcase of claim 3, wherein said tray compartment includes a second battery compartment configured to reversibly receive and retain a second removable rechargeable battery bank cartridge and wherein said second removable rechargeable battery bank includes a Bluetooth wireless module that is configured to facilitate wireless communication with the second removable rechargeable battery bank cartridge.

12. The suitcase of claim 11, wherein said second battery compartment is an extension of the first battery compartment.

13. The suitcase of claim 3, wherein said removable rechargeable battery bank cartridge includes a pull tab configured to extend out of the battery compartment toward the top external surface when the removable rechargeable battery bank cartridge is received within the battery compartment so as to facilitate removal of the battery bank cartridge from the battery compartment.

14. The suitcase of claim 3, wherein said battery compartment includes an electrical connector that is configured to electrically interface with a battery interface on the removable rechargeable battery bank cartridge when the removable rechargeable battery bank cartridge is received within the battery compartment.

15. The suitcase of claim 14, wherein said electrical connector is electrically coupled to one or more access ports that are accessibly mounted to an external surface of the suitcase.

16. The suitcase of claim 15, wherein said one or more access ports includes a plurality of Universal Serial Bus connectors.

17. The suitcase of claim 14, wherein said electrical connector is electrically coupled to a plurality of access ports some of which being accessibly mounted to an external surface of the suitcase and some of which being mounted within the tray compartment, said plurality of access ports including a plurality of Universal Serial Bus Connectors.

18. The suitcase of claim 17, wherein said plurality of access ports are configured to facilitate simultaneous charging of a plurality of electronic devices by said removable rechargeable battery bank cartridge.

19. The suitcase of claim 17, wherein said plurality of access ports are configured to facilitate simultaneous charging of the removable rechargeable battery bank cartridge and one or more electronic devices by said removable rechargeable battery bank cartridge.

20. The suitcase of claim 17, wherein said plurality of access ports are configured to facilitate simultaneous charging by said removable rechargeable battery bank cartridge of one or more electronic devices residing outside the suitcase and one or more electronic devices residing within the tray compartment.

21. The suitcase of claim 17, wherein said plurality of access ports comprise multiple access ports accessibly mounted within the tray compartment and multiple access ports accessibly mounted externally to the tray compartment, and wherein said multiple access ports accessibly mounted within the tray compartment and said multiple access ports accessibly mounted externally to the tray compartment are configured to convey power with the removable rechargeable battery bank cartridge.

22. The suitcase of claim 2, wherein said door includes an aperture that extends through the door from the tray compartment and is configured to allow passage of one or more power cables there-through.

23. The suitcase of claim 2, wherein said door includes a zippered compartment.

24. The suitcase of claim 1, wherein said tray compartment is accessible via the top external surface via a door hingedly coupled to the top external surface and movable from a closed position that conceals visibility of the tray compartment to an open position that reveals the tray compartment, and wherein said top portion further includes a zipper configured to engage and maintain the hinged door in the closed position when the zipper is closed and allow the hinged door to move into the open position when the zipper is open.

25. The suitcase of claim 24, wherein said hinge is comprised of a living hinge.

26. The suitcase of claim 1, wherein said middle portion is defined by opposing front and back sides and opposing left and right sides,
the back and front sides are configured to meet at corner regions with the left and right sides to define a main storage compartment,
wherein said middle portion includes an access panel that extends across the front side to mid-regions in both the left and right sides, and
wherein a zipper is provided to reversibly join and unjoin said access panel to adjacent regions of the suitcase.

27. The suitcase of claim 14, wherein said electrical connector and said battery interface are pogo pin type connectors that are configured to connect with one another when the removable rechargeable battery bank cartridge is received within the battery compartment.

28. The suitcase of claim 3, wherein said removable rechargeable battery bank cartridge includes:
a battery charge indicator comprising a user interactive button and a display that is configured to emit light representing the level of charge remaining in the removable rechargeable battery bank cartridge in response to activation of the button;
a plurality of externally mounted charging ports, said plurality of externally mounted charging ports include two USB-A ports and one USB-C port;
a rechargeable battery having a charging capacity of 18000 mAh;
wireless connectivity circuitry including Bluetooth Low Energy module and a wireless access hotspot configured to allow access to the internet; and
a pogo pin connector configured to connect with a pogo pin connector mounted within the battery compartment.

29. The suitcase of claim 11, wherein said second removable rechargeable battery bank cartridge includes:
a battery charge indicator comprising a user interactive button and a display that is configured to emit light representing the level of charge remaining in the rechargeable battery bank cartridge in response to activation of the button;
a plurality of externally mounted charging ports, said plurality of externally mounted charging ports include two USB-A ports and one USB-C port;
a charging capacity of 18000 mAh;
wireless connectivity circuitry including Bluetooth Low Energy module and a wireless access hotspot configured to allow access to the internet; and
a pogo pin connector configured to connect with a pogo pin connector mounted within the tray compartment.

30. The suitcase of claim 1, wherein said plurality of horizontally spaced swivel wheels have a hubless configuration.

31. The suitcase of claim 1, wherein said plurality of horizontally spaced swivel wheels are mounted within wells formed in the bottom portion of the suit case.

32. The suitcase of claim 1, wherein each of said plurality of horizontally spaced swivel wheels are detachably mounted via a pin that extends from the bottom portion into a sleeve that is coupled to the wheel, the pin includes a recessed end region and the sleeve includes a biased depressible button clasp, in the undepressed state the clasp is configured to be biased toward the recessed region of the pin, in the depressed state the clasp is configured to move away from the recessed region of the pin and thereby unlocking the wheel from the pin.

33. The suitcase of claim 32, wherein each of said plurality of horizontally spaced swivel wheels are mounted within wheel wells formed into the bottom external surface of the bottom portion.

34. The suitcase of claim 33, wherein the bottom external surface of the bottom portion has multiple corners and wherein said wheel wells are position in the corners.

35. The suitcase of claim 26 further comprising a locking mechanism on the left or right side of the middle portion and wherein said zipper includes one or more pull tabs that are configured at their distal ends to be received and retained in said locking mechanism and thereby lock the main storage compartment.

36. The suitcase of claim 35, wherein said access panel is formed is pliable and wherein said bottom portion is rigidly formed of a molded polymer or metal material.

37. The suitcase of claim 1, wherein said top, bottom and middle portions are formed of molded rigid plastic.

38. The suitcase of claim 26 wherein said top and bottom portions are formed of molded rigid plastic and said access panel is formed of pliable material.

39. The suitcase of claim 8 further comprising an interactive electronic locking mechanism.
